(19) United States
(12) Patent Application Publication
(10) Pub. No.: US 2012/0062342 A1
(43) Pub. Date: Mar. 15, 2012

(54) MULTI BAND-PASS FILTER

(75) Inventors: Wei-Shiang HUANG, Changhua County (TW); Wei-Hao YEH, Taichung City (TW)

(73) Assignees: UNIVERSAL GLOBAL SCIENTIFIC INDUSTRIAL CO., LTD., Nantou County (TW); UNIVERSAL SCIENTIFIC INDUSTRIAL (SHANGHAI) CO., LTD., Shanghai (CN)

(21) Appl. No.: 13/053,509

(22) Filed: Mar. 22, 2011

(30) Foreign Application Priority Data
Sep. 10, 2010 (TW) 99130741

(51) Int. Cl. H01P 1/203

(52) U.S. Cl. 333/204

(57) ABSTRACT

A multi band-pass filter includes a first resonator and a second resonator. The first resonator has a first frequency pass band and a second frequency pass band. Moreover, the second resonator is electromagnetically coupled to another end of the first resonator. The second resonator has a third frequency pass band and a fourth frequency pass band, wherein the third frequency pass band overlaps (or is congruous with) the first frequency pass band and the fourth frequency pass band overlaps the second frequency pass band.

### BACKGROUND OF THE INVENTION

1. Field of the Invention

The present invention relates to a multi band-pass filter, and more particularly, to a dual band-pass filter.

2. Description of Related Art

The microwave filter fabricated on basis of micro-strip lines is usually subject to frequency doubling effect. As such, connecting such band-pass microwave filter to a low pass microwave filter becomes necessary for the elimination of the frequency doubling effect.

However, the elimination of frequency doubling effect with a low pass microwave filter may complicate the design of the entire micro-strip circuit and limit the usage of the space thereof. The above-mentioned deficiency may worsen in the case of the dual band-pass filter, which gradually gains its popularity as the single band-pass filter is limited in the application.

In performing electromagnetic interference tests on the dual band-pass microwave filter, the second, the third and the fourth order harmonic waves of the main frequency usually fail the standards. Hence, on the premises of not significantly increasing manufacturing costs and size of the entire circuitry, how to design a dual band-pass microwave filter in compliance with the prevailing standards has been a challenge to the industry.

### SUMMARY OF THE INVENTION

Regarding to the aforementioned disadvantages, the objective of the present invention is to disclose a multi band-pass microwave filter which utilizes a resonator consisting of multiple micro-strip lines to ensure the desired frequency bands may overlap with each other, effectively eliminating the frequency doubling problem.

According to an embodiment, the multi band-pass microwave filter of the present invention comprises a first resonator and a second resonator. The first resonator is configured with micro-strip lines of two different characteristic impedances and provides a first frequency pass band and a second frequency pass band. Similarly, the second resonator is configured with micro-strip lines of two different characteristic impedances and electromagnetically coupled to the first resonator. The second resonator provides a third frequency pass band and a fourth frequency pass band, and the third frequency pass band may be configured to overlap (or in congruous with) the first frequency pass band and the fourth frequency pass band may overlap (or in congruous with) the second frequency pass band.

According to another embodiment, the multi band-pass microwave filter of the present invention further comprises a third resonator. The third resonator is configured with micro-strip lines of two different characteristic impedances and symmetrically and reversely disposed with respect to the first resonator. The third resonator is electromagnetically coupled to the second resonator and provides the first frequency pass band and the second frequency pass band.

In summary, the multi band-pass microwave filter according to the embodiments of the present invention uses multiple stepped impedance resonators that are electromagnetically coupled together to ensure the harmonic waves are staggered for effectively eliminating the problem of the frequency doubling and for ensuring the desired pass bands may be overlapping.

Consequently, the multi band-pass microwave filter according to the embodiments of the present invention does not require to be connected in series with a low pass microwave filter to effectively eliminate the frequency doubling problem to provide dual pass bands and further reduce the area taken by the microwave filter.

### BRIEF DESCRIPTION OF THE DRAWINGS

FIG. 1 shows a structural diagram of a first resonator according to the present invention;

FIG. 2 shows a diagram of frequency response from the first resonator of the present invention;

FIG. 3 shows a structural diagram of a second resonator according to the present invention;

FIG. 4 shows a diagram of frequency response from the second resonator of the present invention;

FIG. 5 shows a structural diagram of a multi band-pass microwave filter according to a first embodiment of the present invention;

FIG. 6 shows a diagram of frequency response from the multi band-pass microwave filter according to the first embodiment of the present invention;

FIG. 7 shows a structural diagram of another multi band-pass microwave filter according to a second embodiment of the present invention;

FIG. 8 shows a diagram of frequency response from the multi band-pass microwave filter according to the second embodiment of the present invention;

FIG. 9 shows another diagram of frequency response from the multi band-pass microwave filter according to the second embodiment of the present invention; and

FIG. 10 shows another structural diagram of the multi band-pass microwave filter according to the second embodiment of the present invention.

### DETAILED DESCRIPTION OF THE PREFERRED EMBODIMENTS

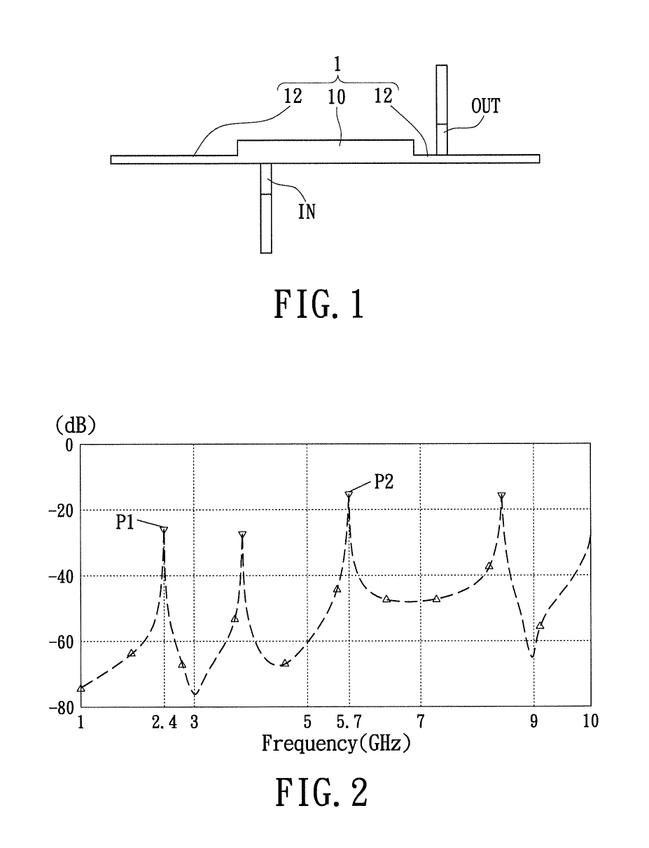

Refer now to FIG. 1, wherein a structural diagram of a first resonator according to the present invention is shown. The first resonator 1 may include a micro-strip line 10 of a first characteristic impedance electrically connected with two micro-strip lines 12 of a second characteristic impedance. That the micro-strip line 10 of the first characteristic impedance and the micro-strip line 12 of the second characteristic impedance provides a first frequency pass band and a second frequency pass band. In one implementation, an impedance value of the first characteristic impedance is less than an impedance value of the second characteristic impedance. Additionally, one end of the micro-strip line 10 having the first characteristic impedance in the first resonator 1 is electrically connected to the micro-strip line 12 having the second characteristic impedance. Meanwhile the other end of the micro-strip line 10 is electrically connected to the other micro-strip line 12 having the second characteristic impedance. As described above, the first resonator 1 may be a stepped impedance resonator or any other resonators enabling a first frequency pass band and a second frequency pass band.

Refer again to FIG. 1. A frequency response test on the first resonator 1 may be performed by having a radio frequency (RF) signal received at an input port (IN) and an output at an output port (OUT). FIG. 2 suggests the first resonator 1 may be associated with the first frequency pass band (P1) in proximity of 2.4 GHz and the second frequency pass band (P2) around 5.7 GHz.

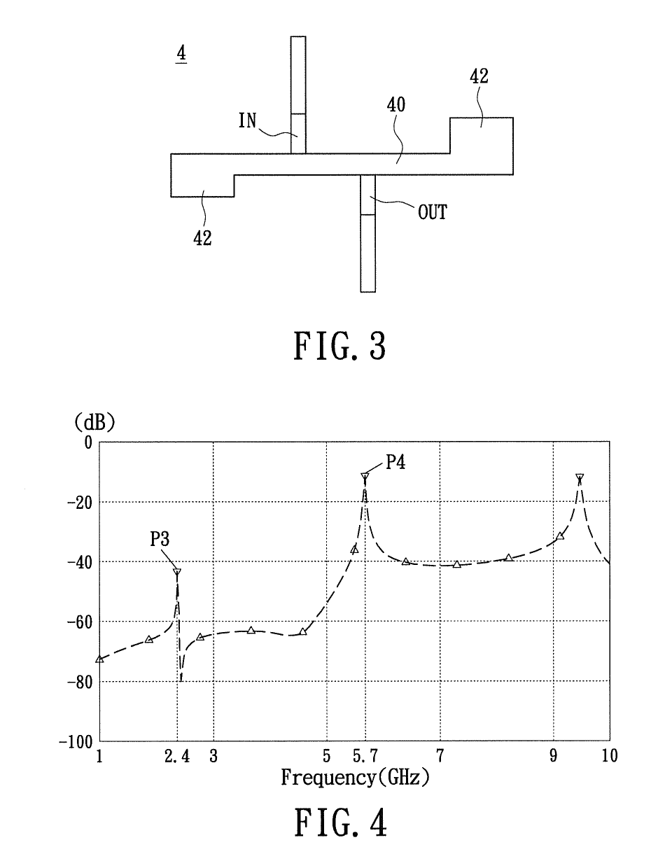

Refer next to FIG. 3, wherein a structural diagram of a second resonator 4 according to the present invention is shown. The second resonator 4 is formed by electrically connecting a micro-strip line 40 of a third characteristic impedance with two micro-strip lines 42 of a fourth characteristic impedance. The two micro-strip lines 42 of the fourth characteristic impedance are respectively electrically connected to both ends of the micro-strip line 40 of the third characteristic impedance and reversely symmetrically disposed. Herein, an impedance value of the third characteristic impedance and an impedance value of the fourth characteristic impedance are different so as to present a third frequency pass band and a fourth frequency pass band for the second resonator 4. In one implementation, the impedance value of the fourth characteristic impedance is less than the impedance value of the third characteristic impedance. As described above, the second resonator 4 may be a stepped impedance resonator or any other resonators enabling two pass bands.

Refer once again to FIG. 3. Another frequency response test may be performed on the second resonator 4 by having an RF signal received at an input port (IN) and having an output obtained at an output port (OUT). FIG. 4 indicates that the frequency response of the second resonator 4 which is associated with the third frequency pass band (P3) in proximity of 2.4 GHz and the fourth frequency pass band (P4) around 5.7 GHz.

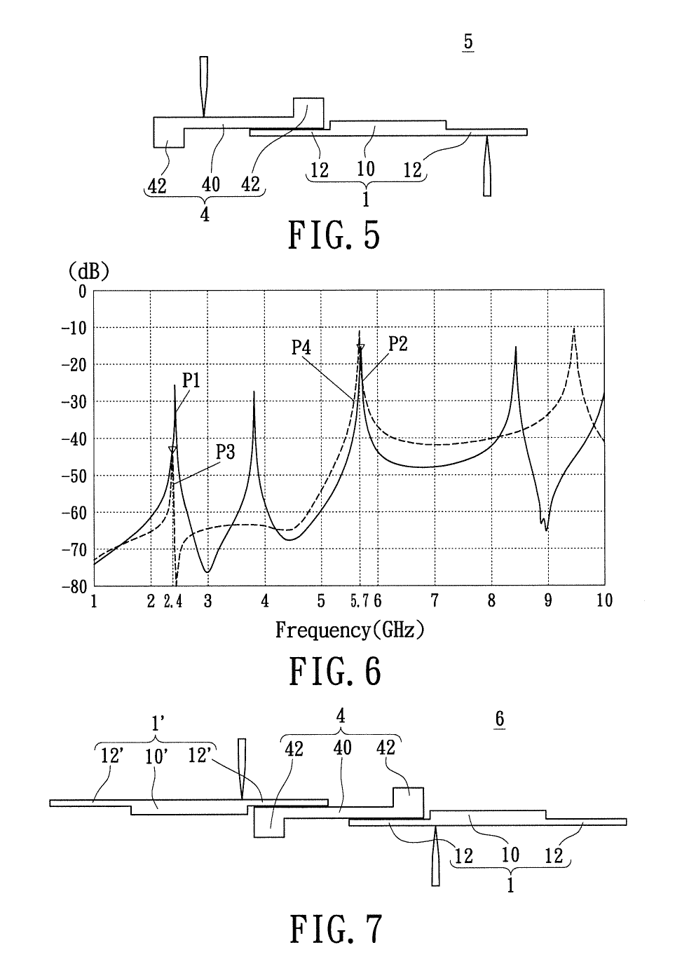

Refer next to FIG. 5 conjunctively with FIGS. 1 and 3, wherein a structural diagram of a multi band-pass microwave filter 5 according to a first embodiment of the present invention is shown. The multi band-pass microwave filter 5 comprises a first resonator 1 and a second resonator 4. More specifically, the micro-strip lines 12 of the second characteristic impedance in the first resonator 1 is electromagnetically coupled to the micro-strip lines 42 of the fourth characteristic impedance in the second resonator 4.

Refer subsequently to FIG. 6 in conjunction with FIG. 5, wherein a diagram of a frequency response from the multi band-pass microwave filter 5 according to the first embodiment of the present invention is shown. FIG. 6 suggests that the first frequency pass band (P1) associated with the first resonator 1 may overlap (or in congruence with) the third frequency pass band (P3) associated with the second resonator 4. At the same time, the second frequency pass band (P2) associated with the first resonator 1 also overlaps (or in congruence with) the fourth frequency pass band (P4) associated with the second resonator 4.

In other words, other frequency responses between the first resonator 1 and the second resonator 4 in the multi band-pass microwave filter 5 may not overlap to ensure only two pass bands may be associated with the filter 5 while effectively reducing the frequency doubling problem and the area occupied by the microwave filter.

Refer now to FIG. 7 conjunctively with FIG. 5, wherein a structural diagram of another multi band-pass microwave filter according to a second embodiment of the present invention is shown. Compared the multi band-pass microwave filter 5 set forth in the first embodiment, the multi band-pass microwave filter 6 according to the second embodiment of the present invention further comprises a third resonator 1′. In one implementation, the configuration of the third resonator 1′ may be identical to that of the first resonator 1 and may also have the same physical features of the first resonator 1. The third resonator 1′ comprises a micro-strip line 10′ of the first characteristic impedance and micro-strip lines 12′ of the second characteristic impedance.

In the second embodiment, the configuration of the third resonator 1′ is reversely symmetric to the one of the first resonator 1. The micro-strip line 10′ of the first characteristic impedance is electrically connected to the two micro-strip lines 12′ of the second characteristic impedance. Moreover, the micro-strip line 12′ of the second characteristic impedance in the third resonator 1′ and the micro-strip line 12 of the second characteristic impedance in the first resonator 1 are respectively installed at the both ends of the second resonator 4 and electromagnetically coupled to the micro-strip line 42 of the fourth characteristic impedance in the second resonator 4 respectively.

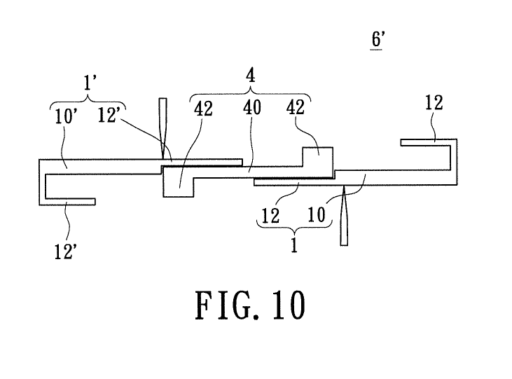

Furthermore, the micro-strip line 12′ of the second characteristic impedance in the first resonator 1 and the micro-strip line 12′ of the second characteristic impedance in the third resonator 1′ may both be a straight micro-strip line or a curved micro-strip line. In the case that the micro-strip lines 12 and 12′ are a curved micro-strip line, the area occupied by the multi band-pass microwave filter 6′ may be further reduced as shown in FIG. 10.

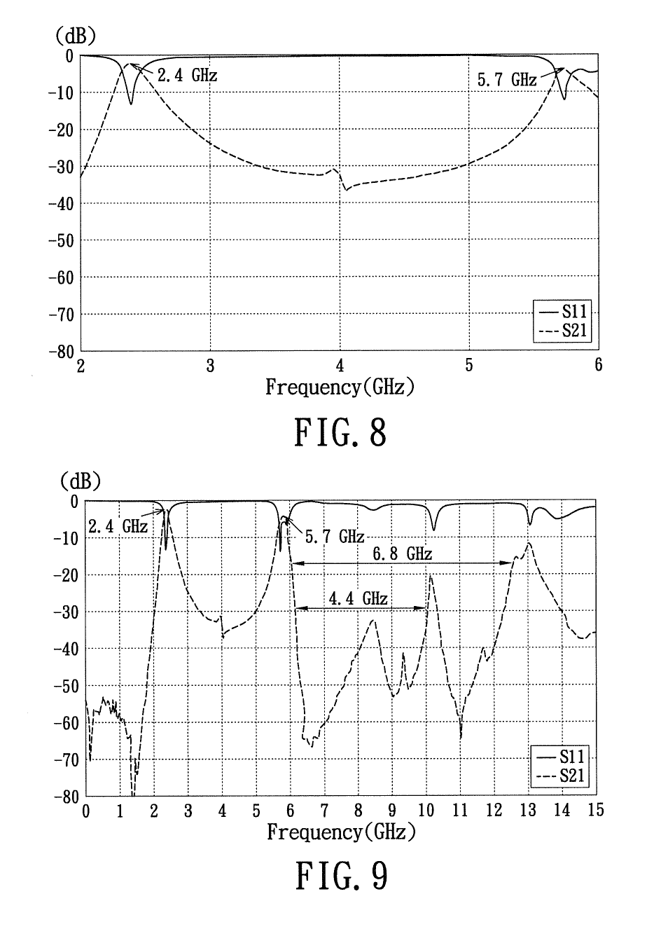

Refer to FIG. 8 together with FIG. 7, wherein a diagram of a frequency response from the multi band-pass microwave filter 6 according to the second embodiment of the present invention is shown. The frequency response of the multi band-pass microwave filter 6 shown in FIG. 8 indicates that a first frequency pass band in proximity of 2.4 GHz and another frequency pass band around 5.7 GHz may be associated with the filter 6. Besides, no other double frequency bands exist between these two frequency pass bands. Therefore, the multi band-pass microwave filter 6 may effectively suppress other multiplied frequencies so as to mitigate the problem derived from frequency doubling and to further reduce the size of the microwave filter.

Refer next to FIG. 9 conjunctively with FIG. 7, wherein a frequency response from the multi band-pass microwave filter 6 according to the second embodiment of the present invention is shown. It can be seen from FIG. 9 that the multi band-pass microwave filter 6 may be associated with two pass bands (2.4 GHz and 5.7 GHz) in the frequency range of 0˜15 GHz without causing other pass bands, thus effectively increasing an available bandwidth for the filter 6.

In summary, the multi band-pass microwave filter according to the present invention as illustrated above applies electromagnetic couplings of multiple stepped impedance resonators, separating apart the pass bands of the resonators of the filter. In doing so, the filter according to the present invention may not allow microwave signal which has passed the first resonator to pass the subsequent resonators such as the second resonator and the third resonator. Meanwhile, the filter according to the present invention may be capable of overlapping the pass bands of the resonators of predetermined impedances to ensure the desired pass bands of the filter could be prepared. Accordingly, the multi band-pass microwave filter according to the present invention does not require additional low pass microwave filter connected in series to effectively resolve the frequency doubling problem and reduce the area occupied by the microwave filter.

It should be noticed that, however, the descriptions illustrated supra set forth simply the preferred embodiments of the present invention. All changes, alternations or modifications conveniently considered by those skilled ones in the art are deemed to be encompassed within the scope of the present invention delineated by the following claims.

What is claimed is:

1. A multi band-pass microwave filter, comprising:
a first resonator, which is configured with micro-strip lines of two different characteristic impedances and provides a first frequency pass band and a second frequency pass band;
a second resonator, which is configured with micro-strip lines of two different characteristic impedances and electromagnetically coupled to the first resonator, and provides a third frequency pass band and a forth frequency pass band, wherein the third frequency pass band overlaps the first frequency pass band and the fourth frequency pass band overlaps the second frequency pass band; and
a third resonator, which is configured with micro-strip lines of two different characteristic impedances and placed symmetrically and reversely with respect to the first resonator, and is electromagnetically coupled to the second resonator for providing the first frequency pass band and the second frequency pass band.

2. The multi band-pass microwave filter according to claim 1, wherein each of the first resonator and the third resonator consists of the micro-strip lines of a first characteristic impedance, and both ends of the micro-strip line of the first characteristic impedance are electrically connected to the micro-strip lines of a second characteristic impedance respectively.

3. The multi band-pass microwave filter according to claim 2, wherein the second resonator further consists of the micro-strip lines of a third characteristic impedance, and both ends of the micro-strip line of the third characteristic impedance electrically connected to the micro-strip lines of a fourth characteristic impedance respectively.

4. The multi band-pass microwave filter according to claim 3, wherein the micro-strip line of the second characteristic impedance in the first resonator and the micro-strip line of the second characteristic impedance in the third resonator are electromagnetically coupled to the micro-strip line of the fourth characteristic impedance in the second resonator respectively.

5. The multi band-pass microwave filter according to claim 4, wherein an impedance of the first characteristic impedance is less than an impedance value of the second characteristic impedance, and an impedance value of the fourth characteristic impedance is less than an impedance value of the third characteristic impedance.

6. A multi band-pass microwave filter, comprising:
a first resonator, which consists of micro-strip lines of two different characteristic impedances and provides a first frequency pass band and a second frequency pass band; and
a second resonator, which consists of micro-strip lines of two different characteristic impedances and is electromagnetically coupled to the first resonator, wherein the second resonator provides a third frequency pass band and a fourth frequency pass band, and the third frequency pass band overlaps the first frequency pass band and the forth frequency pass band overlaps the second frequency pass band.

7. The multi band-pass microwave filter according to claim 6, wherein the first resonator further consists of the micro-strip line of a first characteristic impedance and the both ends of the micro-strip line of the first characteristic impedance are electrically connected to the micro-strip line of a second characteristic impedance respectively.

8. The multi band-pass microwave filter according to claim 7, wherein the second resonator further consists of the micro-strip line of a third characteristic impedance, and the both ends of the micro-strip line of the third characteristic impedance is electrically connected to the micro-strip line of a fourth characteristic impedance respectively.

9. The multi band-pass microwave filter according to claim 8, wherein the micro-strip line of the second characteristic impedance in the first resonator is electromagnetically coupled to the micro-strip line of the fourth characteristic impedance in the second resonator.

10. The multi band-pass microwave filter according to claim 9, wherein an impedance value of the micro-strip line of the first characteristic impedance is less than an impedance value of the micro-strip line of the second characteristic impedance, and an impedance value of the micro-strip line of the fourth characteristic impedance is less than an impedance value of the micro-strip line of the third characteristic impedance.
